(19) United States
(12) Patent Application Publication
(10) Pub. No.: US 2020/0062618 A1
(43) Pub. Date: Feb. 27, 2020

(54) POLLUTANT REMOVING SYSTEM FOR WATER TREATMENT

(71) Applicant: AMOGREENTECH CO., LTD., Gimpo-si (KR)

(72) Inventors: Jin LEE, Incheon (KR); Kyung Gu HAN, Goyang-si (KR)

(21) Appl. No.: 16/487,617

(22) PCT Filed: Mar. 7, 2018
(86) PCT No.: PCT/KR2018/002712

§ 371 Date: Aug. 21, 2019

(30) Foreign Application Priority Data
Mar. 8, 2017 (KR) 10-2017-0029649

(51) Int. Cl. C02F 1/463; C02F 1/44; C02F 1/461

(52) U.S. Cl. CPC C02F 1/463; C02F 1/44; C02F 1/46109; C02F 2201/4613; C02F 2001/46133; C02F 2001/46152; C02F 2001/46119

(57) ABSTRACT

Provided is a pollutant removing system for water treatment. The pollutant removing system for water treatment includes: a raw water supply tank; a separation membrane tank; and an electrocoagulation tank which is disposed between the raw water supply tank and the separation membrane tank, and coagulates pollutants contained in the raw water by using the principles of electrocoagulation, wherein a plurality of the electrocoagulation tanks are provided and connected to each other in series.

### TECHNICAL FIELD

The present invention relates to a pollutant removing system for water treatment, and more specifically, to a pollutant removing system for water treatment which efficiently removes pollutants included in raw water using a principle of electro-coagulation.

### BACKGROUND ART

Contamination of water due to nitrates is caused by industrial wastewater or use of excessive chemical fertilizers in agricultural areas. When a nitrogen-containing compound is introduced into water, quality degradation of the water, such as eutrophication, occurs. Further, when human beings drink water containing the nitrogen-containing compound, the nitrogen-containing compound may cause health disorders, such as cancer, cyanosis, or the like.

Currently, methods of removing nitrates from wastewater include an ion exchange resin method, a biological degradation method, a reverse osmosis method, an electrodialysis method, a catalyst denitrification method, and the like. The ion exchange resin method is a useful process for groundwater treatment, but treatment water includes a lot of unnecessary remaining components. The biological degradation method is a very useful process for surface water treatment, but generally has a disadvantage of a long treatment time. Further, the reverse osmosis method and the electrodialysis method may achieve nitrate removal efficiency of about 65% but have a disadvantage of high energy input cost.

Accordingly, an electrocoagulation method through which an amount of an applying current is adjusted to provide an exact amount of coagulating agent, automation is facilitated, energy consumption is low, and pollutants are destabilized, coagulated, and separated using one process has been in the spotlight

In the electrocoagulation method, when a current is supplied, metal ions are eluted from an electrode plate, the eluted metal ions are coagulated and adsorbed onto contaminants in wastewater, and thus the contaminants rise up or are deposited due to hydrogen and chlorine gas.

However, the conventional water treatment system using the electrocoagulation method includes one electrocoagulation tank appropriate for treatment capacity. Accordingly, a size of the electrocoagulation tank should be also increased according to treatment capacity, and since a treatment process is performed only once, a coagulation rate and removal efficiency of contaminants should be decreased.

Further, in the conventional electrocoagulation tank, since a method in which a plurality of electrodes are arranged and treatment water passes between the electrodes is simply used, overall water treatment efficiency is decreased.

### DISCLOSURE

### Technical Problem

The present invention is directed to providing a pollutant removing system for water treatment capable of increasing the aggregation rate of pollutants since a plurality of electrocoagulation tanks are connected in series to cause a sequential electrocoagulation reaction.

Further, the present invention is directed to providing a pollutant removing system for water treatment that can reduce the size of electrocoagulation tanks and the size of an electrode plate used in the electrocoagulation tank compared to a conventional system for the same treatment capacity since a plurality of electrocoagulation tanks are connected in series.

### Technical Solution

One aspect of the present invention provides a pollutant removing system for water treatment which includes a raw-water supply tank, a separation membrane tank, and a plurality of electrocoagulation tanks disposed between the raw-water supply tank and the separation membrane tank and configured to coagulate a contaminant included in raw water using a principle of electrocoagulation, wherein the plurality of electrocoagulation tanks are connected in series.

The plurality of electrocoagulation tanks may have the same treatment capacity and include the same number of electrode plates.

Each of the electrocoagulation tanks may include a housing, which includes an internal space with an open upper portion, and an electrode unit which is disposed in the internal space and has a plurality of electrode plates, which are disposed therein to be spaced apart from each other so that the contaminant included in raw water supplied from the outside is coagulated using the principle of electrocoagulation, wherein the internal space may include a first chamber into which the raw water is introduced, a second chamber which is formed above the first chamber and in which the electrode unit is disposed, and a third chamber which temporarily stores treated water of which an electrocoagulation reaction is completed in the second chamber.

The plurality of electrode plates may include a pair of power electrodes to which power supplied from the outside is applied and a plurality of sacrificial electrodes which are disposed between the pair of power electrodes in parallel to be spaced apart from each other by a predetermined distance.

Insertion grooves for fixing positions of the power electrodes and the sacrificial electrodes may be formed inward from an inner wall of the housing, which defines the second chamber, in a height direction.

The electrocoagulation tank may further include an electrode case to which the power electrodes and the sacrificial electrodes are coupled to be attachable or detachable, wherein the electrode case may include insertion grooves formed inward from an inner wall thereof in a height direction so that positions of the power electrodes and the sacrificial electrodes are fixed, and the electrode case may be coupled to the second chamber of the housing. In this case, the electrode case may be an insulator or a nonconductor.

An inlet pipe that has a predetermined length and has a plurality of spray holes formed thereon may be disposed in the first chamber, wherein the inlet pipe may be disposed in a direction parallel with an arrangement direction of the electrode plates.

A diffuser, which has a predetermined length and has a plurality of discharge holes formed thereon, may be disposed on the first chamber, wherein the diffuser may discharge bubbles through the discharge holes using air supplied from the outside.

The second chamber and the third chamber may be partitioned by a partition wall which protrudes to a predetermined height in the inner space, and treated water of which an electrocoagulation reaction is completed in the second chamber may pass over an upper end of the partition wall and move to the third chamber.

At least one discharge hole for discharging the treated water to the outside may be formed in a bottom surface of the third chamber.

The housing may be made of an insulator or a nonconductor.

An outer surface of the housing may be coated with a coating layer that has at least one property of chemical resistance, corrosion resistance, and electric insulation property.

The electrocoagulation tanks may include a control unit for controlling power to be supplied to the electrode unit, wherein the control unit may periodically change the polarity of power applied to the electrode unit.

The plurality of electrode plates may be made of any one among iron, aluminum, stainless steel, and titanium.

### Advantageous Effects

According to the present invention, raw water sequentially passes through a plurality of electrocoagulation tanks that are connected in series to allow an electrocoagulation reaction to be caused so as to increase a coagulation rate of contaminants, and thus removal efficiency of a filtration tank can be increased.

Further, since the size of an electrode plate used in each of the electrocoagulation tank can be reduced while being reduced the size of the electrocoagulation tank compared to a conventional system for the same treatment capacity, and installation costs are reduced.

Furthermore, since water comes into contact with a plurality of electrode plates with a uniform area while a water level is simultaneously uniformly maintained, the overall treatment speed can be increased. Further, since bubbles formed by a diffuser are supplied to the treated water to prevent the electrode plates from being contaminated and/or damaged or remove foreign materials adhering to the electrode plates, and maintenance costs can be reduced.

### DESCRIPTION OF DRAWINGS

FIG. 1 is a schematic diagram illustrating an overall pollutant removing system for water treatment according to one embodiment of the present invention.

FIG. 2 is a perspective view schematically illustrating an electrocoagulation tank that is applicable to the pollutant removing system for water treatment according to one embodiment of the present invention.

FIG. 3 is a view illustrating main components of FIG. 2.

FIG. 4 is a partial cut-out view illustrating an internal configuration of a housing in FIG. 3.

FIG. 5 is a cross-sectional view of FIG. 3.

FIG. 6 is a schematic view illustrating a case in which a diffuser is included in FIG. 3.

FIG. 7 is a cross-sectional view of FIG. 6.

FIG. 8 is a schematic view illustrating an inlet pipe and a diffuser that are applicable to the electrocoagulation tank according to one embodiment of the present invention.

FIG. 9 is a view illustrating another type of an electrocoagulation tank that is applicable to the pollutant removing system for water treatment according to one embodiment of the present invention.

FIG. 10 is an exploded view of FIG. 9.

FIG. 11 is a bottom view of an electrode case applied to FIG. 9.

### MODES OF THE INVENTION

Hereinafter, embodiments will be described in detail with reference to the accompanying drawings so that that those skilled in the art may easily perform the embodiments of the present invention. The embodiments of the present invention may be implemented in several different forms and are not limited to the embodiments described herein. Parts irrelevant to description will be omitted in the drawings to clearly explain the embodiments of the present invention, and the same parts or similar parts are denoted by similar reference numerals throughout this specification.

A pollutant removing system for water treatment 1 according to one embodiment of the present invention may coagulate contaminants included in raw water using a principle of electrocoagulation and filter flocs generated from the raw water, treated water may be generated.

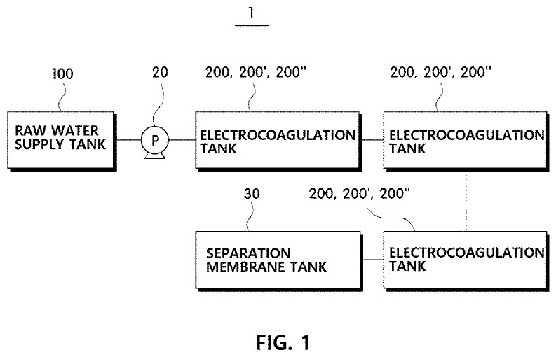

To this end, as shown in FIG. 1, the pollutant removing system for water treatment 1 according to one embodiment of the present invention may include a raw-water supply tank 100, a separation membrane tank 300, and a plurality of electrocoagulation tanks 200, 200′, and 200″.

The raw-water supply tank 100 may store raw water to be treated and supply the raw water to the electrocoagulation tanks 200, 200′, and 200″ connected with a rear end of the raw-water supply tank 100.

Here, the raw water may be dirty water or wastewater discharged from an industrial facility, a residential space, or the like or may be rainwater, seawater, or the like.

The raw-water supply tank 100 may be formed as a chamber with a predetermined internal space.

In this case, a pump 20 for easily transferring the stored raw water to the electrocoagulation tanks 200, 200′, and 200″ may be connected with the rear end of the raw-water supply tank 100.

Meanwhile, the separation membrane tank 300 may be connected with rear ends of the electrocoagulation tanks 200, 200′, and 200″ and remove the flocs generated in the electrocoagulation tanks 200, 200′, and 200″ from the raw water. The separation membrane tank 300 may be a known filtering apparatus in which at least one filter member (not shown) is disposed inside a chamber.

Since the raw-water supply tank 100 and the separation membrane tank 300 are general tanks that are applied to a water treatment system, detailed descriptions thereof will be omitted.

The electrocoagulation tanks 200, 200′, and 200″ may be disposed between the raw-water supply tank 100 which supplies the raw water and the separation membrane tank 300 which filters foreign materials included in the raw water. Since the electrocoagulation tanks 200, 200′, and 200″ coagulate contaminants included in the raw water, the removal efficiency of contaminants in the separation membrane tank 300 can be increased.

That is, since the electrocoagulation tanks 200, 200′, and 200″ coagulate contaminants, which are included in the raw water, into mass-shaped flocs using a principle of electrocoagulation, the separation membrane tank 300 may easily filter the flocs.

The electrocoagulation tanks 200, 200′, and 200″ may include a plurality of electrode plates 221 and 222, and in a case in which power is applied to the electrode plates 221 and 222, metal ions may be eluted in an electrolysis process. Accordingly, the metal ions may be coagulated and adsorbed with the contaminants included in the raw water, and thus the contaminants may be coagulated into mass-shaped flocs.

That is, when a predetermined voltage is applied to a sacrificial electrode 222 of the plurality of electrode plates 221 and 222, a metal is eluted from the electrode plate, and thus hydroxides may be produced. Further, since the hydroxides generated through the process may be coagulated with colloids included in the raw water and may be deposited, the contaminants included in the raw water may be electrically neutralized with metal positive ions which are eluted from the electrode plate by electrical energy. Accordingly, since a coagulation reaction simultaneously occurs on contaminants and an oxidation reaction and a reduction reaction also occur, the contaminants may be removed from the raw water.

For example, in a case in which the electrode plates 221 and 222 are made of metal, contaminants may be formed into polymer hydroxide flocs through the following reaction.

### Mechanism 1

<Positive-Electrode Reaction>

Fe_{(solid)}→Fe²⁺_{(aqueous solution)}+2e⁻

Fe²⁺_{(aqueous solution)}+2OH⁻_{(aqueous solution)}→Fe(OH)_{2 (solid)}

<Negative-Electrode Reaction>

2H₂O_{(liquid)}+2e⁻→H_{2(gas)}+2OH⁻_{(aqueous solution)}

<Overall Reaction>

Fe_{(solid)}+2H₂O_{(liquid)}→Fe(OH)_{2(solid)}+H_{2(gas)}

<Oxidation Reaction>

2Cl⁻→Cl₂+2e⁻

Cl_{2(gas)}+H₂O→HOCl+H⁺+Cl⁻

Fe(OH)₂+HOCl→Fe(OH)_{3(solid)}+Cl⁻

### Mechanism 2

<Positive-Electrode Reaction>

4Fe_{(gas)}→4Fe²⁺_{(adequate liquid)}+8e⁻

4Fe²⁺_{(adequate liquid)}+10H₂O_{(liquid)}+O_{2(gas)}→4Fe(OH)_{3(solid)}+8H⁺_{(adequate liquid)}

<Negative-Electrode Reaction>

8H⁺_{(adequate liquid)}+8e⁻→4H_{2(gas)}

<Overall Reaction>

4Fe_{(solid)}+10H₂O_{(liquid)}→4Fe(OH)_{3(solid)}+4H_{2(gas)}

That is, iron may be eluted in a solution as ferrous iron and may be oxidized to ferric iron by dissolved oxygen and hypochlorous acid produced by chlorine oxidation, and thus Fe²⁺, that is, a positive ion, may be hydrolyzed in water and may be adsorbed with nitrates, and thus amorphous polymeric hydroxide flocs (flocs) are formed and may be deposited while a reaction formula of nFe(OH)_{3(solid)}+NO₃⁻_{(aqueous solution)}→[Feₙ(OH)₃ₙ.NO₃⁻]_{(solid)} is satisfied. Accordingly, the generated hydroxide flocs are collected in hydrogen gas and float due to buoyancy, and thus NO₃⁻ may be removed from a surface of the raw water. The principle of electrocoagulation is well known in the art, and a detailed description thereof will be omitted.

In this case, the pollutant removing system for water treatment 1 according to one embodiment of the present invention may include the plurality of electrocoagulation tanks 200, 200′, and 200″, and the plurality of electrocoagulation tanks 200, 200′, and 200″ may be sequentially disposed between the raw-water supply tank 100 and the separation membrane tank 300 in series.

Accordingly, while the raw water supplied from the raw-water supply tank 100 sequentially passes through the plurality of the raw-water supply tank 100, coagulation reactions occur a plurality of times, and thus coagulation efficiency of contaminants can be remarkably increased.

Further, while the raw water may sequentially pass through the plurality of electrocoagulation tanks 200, 200′, and 200″, coagulation reactions may occur a plurality of times. Thus, even when the overall sizes of the electrocoagulation tanks 200, 200′, and 200″, especially the number of electrode plates 221 and 222 and the sizes of the electrode plates 221 and 222 used in each of the electrocoagulation tanks 200, 200′, and 200″ for an electrocoagulation reaction, are decreased, the same effect can be obtained.

For example, in a case in which one electrocoagulation tanks 200, 200′, or 200″ is disposed between the raw-water supply tank 100 and the separation membrane tank 300, the one electrocoagulation tanks 200, 200′, or 200″ may use 186 electrode plates, and each of the electrode plates may have a size of 40×60 cm (Comparative Example 1).

On the other hand, in a case in which the three electrocoagulation tanks 200, 200′, or 200″ are sequentially disposed between the raw-water supply tank 100 and the separation membrane tank 300, each of the electrocoagulation tanks 200, 200′, or 200″ may use 50 electrode plates that have a size of 20×40 cm (Embodiment 1).

That is, even when electrode plates having a smaller size than Comparative Example 1 are used, the same effect can be obtained. In addition, as the size of the used electrode plate is decreased, the overall sizes of the electrocoagulation tanks 200, 200′, or 200″ in which the electrode plates are accommodated can also be remarkably decreased.

Accordingly, since the electrocoagulation tanks 200, 200′, and 200″ used for the pollutant removing system for water treatment 1 according to one embodiment of the present invention may use small-sized electrode plates, the manufacturing costs can be reduced, and since the sizes of the electrocoagulation tanks 200, 200′, and 200″ are also decreased, maintenance can be easily performed.

In the present invention, the number of the plurality of electrocoagulation tanks 200, 200′, and 200″ may be the same as that of the electrode plates 221 and 222 installed for the electrocoagulation reaction or may be different therefrom.

Further, although the present invention describes that a size of the electrode plate used for the electrocoagulation tanks 200, 200′, and 200″ is 20×40 cm, the size is not limited thereto, and the size of the electrode plate may be changed according to the overall numbers of the mounted electrocoagulation tanks 200, 200′, and 200″ and the treatment capacity of the entire system.

For example, in a conventional case in which the treatment capacity of the entire system is 100 tons and one electrocoagulation tank is used, 200 electrode plates having a size of 40×60 cm may be used for the electrocoagulation tank. On the other hand, in the pollutant removing system 1 according to one embodiment of the present invention, two electrocoagulation tanks in which 100 electrode plates having a size of 20×40 cm are mounted for the treatment capacity of 100 tons may be connected in series, three electrocoagulation tanks in which 60 electrode plates having a size of 20×40 cm are mounted may be connected in series, or an electrocoagulation tank in which 40 electrode plates having a size of 20×40 cm are mounted, an electrocoagulation tank in which 50 electrode plates having a size of 20×40 cm are mounted, and an electrocoagulation tank in which 60 electrode plates having a size of 20×40 cm are mounted may be connected in series.

Further, the plurality of electrocoagulation tanks 200, 200′, and 200″ may be mounted on a mounted surface at the same height or may be mounted in a multi-stage manner or a stepped manner.

Further, a pump (not shown) for easily transferring treatment water of which an electrocoagulation reaction is completed, may be disposed between a plurality of electrocoagulation tanks 200, 200′, and 200″ that are connected in series.

Meanwhile, the electrocoagulation tank to be applied to the pollutant removing system 1 according to one embodiment of the present invention may use a known electrocoagulation tank in which a plurality of electrode plates are simply arranged, but the electrocoagulation tanks 200, 200′, or 200″ having the following structure may be used.

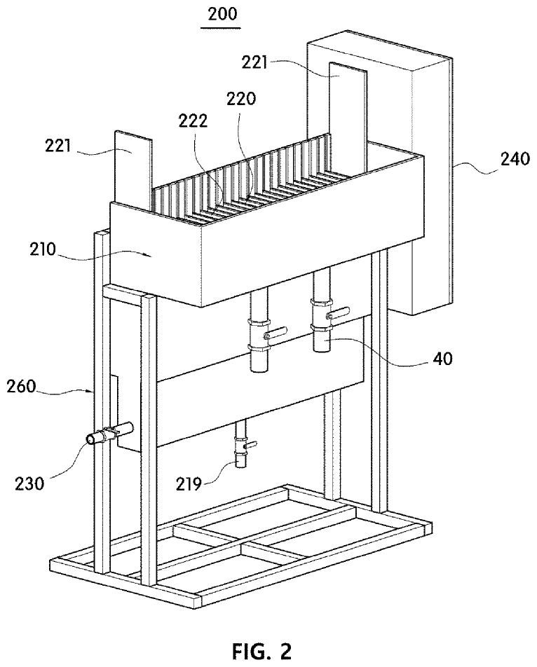

For example, as shown in FIGS. 2, 6, and 9, the electrocoagulation tanks 200, 200′, and 200″ may each include a housing 210 or 210′ and an electrode unit 220, and the housing 210 or 210′ may include a first chamber 211, a second chamber 212, and a third chamber 213.

Specifically, the housing 210 or 210′ may provide a space for temporarily storing the raw water supplied from the raw water supply tank. To this end, the housing 210 or 210′ may be formed in a box shape that has an internal space and an open upper portion.

That is, the housing 210 or 210′ may include an internal space that is a staying space of the raw water, wherein the internal space may be a staying space that is used when the raw water introduced from the raw-water supply tank 100 is transferred to a separate treatment space after contaminants included in the raw water are coagulated through a principle of electrocoagulation.

To this end, the internal space may include a first chamber 211 into which raw water is introduced from the raw-water supply tank 100, a second chamber 212 in which the electrode unit 220 is disposed, and a third chamber 213 which temporarily stores the treated water of which an electrocoagulation reaction is completed in the second chamber 212.

In this case, the second chamber 212 in which the electrode unit 220 is disposed may be formed above the first chamber 211, and the third chamber 213 may be formed side by side of the first chamber 211. Further, the second chamber 212 and the third chamber 213 that are disposed side by side with each other may be partitioned by a partition wall 214 that protrudes in the internal space to a predetermined height.

Accordingly, the first chamber 211 may serve as a buffer space in which the raw water supplied from the raw-water supply tank 100 is stored before the raw water is moved to the second chamber 212 in which the electrocoagulation reaction is performed, and the raw water introduced to the first chamber 211 may be moved to the second chamber 212 while a uniform water level is maintained. Accordingly, the raw water introduced into the second chamber 212 simultaneously comes into contact with the plurality of electrode plates 221 and 222, which compose the electrode unit 220, with a uniform area, and thus an overall treatment speed can be increased.

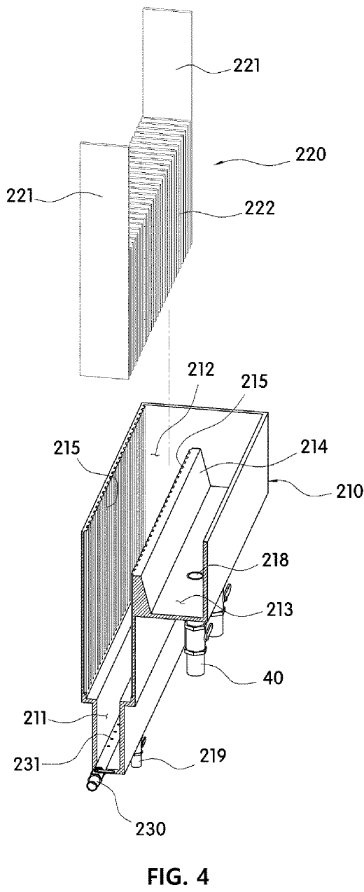

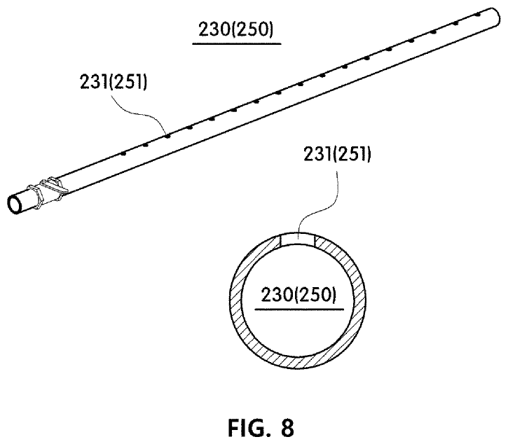

In this case, a hollow inlet pipe 230, which has a predetermined length and in which a plurality of spray holes 231 are formed in a longitudinal direction, may be disposed on the first chamber 211. Accordingly, the raw water supplied from the raw-water supply tank 100 or the electrocoagulation tanks 200, 200′, and 200″ disposed on a front end thereof may be discharged to the first chamber 211 through the spray holes 231 (see FIGS. 4 and 8). In this case, the inlet pipe 230 may be disposed to be parallel with an arrangement direction of the plurality of the electrode plates 221 and 222 that compose the electrode unit 220. Further, a drain discharge hole 218 connected with a drain pipe 219 may be formed in a bottom surface of the first chamber 211 to discharge a drain to the outside.

As described above, in the electrocoagulation tanks 200, 200′, and 200″ applied to the pollutant removing system 1 according to one embodiment of the present invention, after the first chamber 211 is completely filled with the raw water or treated water discharged to the first chamber 211 through the spray hole 231 of the inlet pipe 230, a water level may be slowly increased. Accordingly, the raw water or treated water may move to the second chamber 212 from the first chamber 211 while the water level is uniformly maintained. After that, a coagulation reaction is completely performed in the raw water or treated water introduced into the second chamber 212 through the electrode unit 220, and the raw water or treated water may be introduced into the third chamber 213 from the second chamber 212 over an upper end of the partition wall 214.

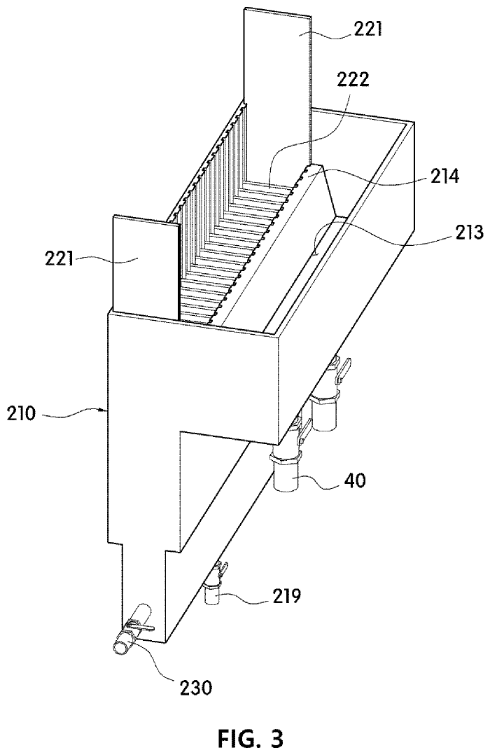

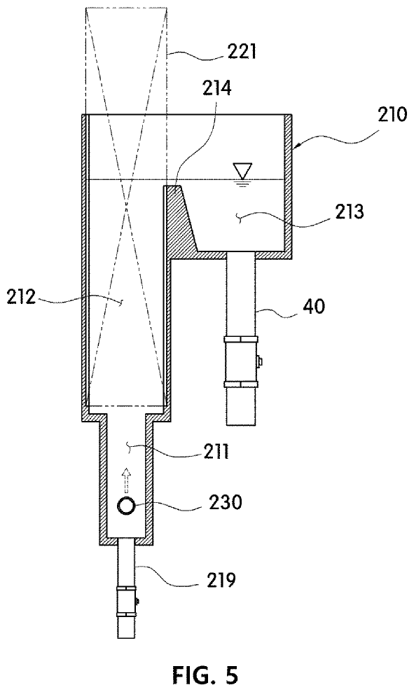

Here, one surface of the partition wall 214 that is formed as a wall surface of the third chamber 213 may be an inclined surface. For example, the inclined surface may be formed to be inclined downward toward the third chamber 213 in a direction from an upper end of the partition wall 214 toward a lower portion thereof (see FIGS. 3 to 5). Accordingly, the treated water overflowing over the upper end of the partition wall 214 may be smoothly moved to the third chamber 213 along the inclined surface.

Further, at least one discharge hole 218 may be formed in a bottom surface of the third chamber 213. The discharge hole 218 may be connected with other electrocoagulation tanks 200, 200′, and 200″, which are disposed on rear ends of the electrocoagulation tanks 200, 200′, and 200″, through a separate pipe 40 or may be connected with a post-treatment device for treating the contaminants coagulated through an electrocoagulation reaction, and thus the treated water may be transferred to the other electrocoagulation tanks 200, 200′, and 200″, which are disposed on the rear ends of the electrocoagulation tanks 200, 200′, and 200″, or transferred to the post-treatment device.

Meanwhile, the housings 210 and 210′ may be formed of an insulator or a nonconductor to prevent a short circuit with the electrode unit 220, which is disposed on the second chamber 212, when power is applied. For example, the housing 210 and 210′ may be formed of a material such as plastic, concrete, plywood, or the like, but the present invention is not limited thereto, and a known insulator or nonconductor may be used as a material of the housings 210 and 210′.

Further, a coating layer that has at least one property of chemical resistance, corrosion resistance, and electric insulation property may be formed on an outer surface of each of the housings 210 and 210′. Accordingly, surface damage to the housing 210 or 210′, which is due to heavy metal and the like included in raw water, may be prevented.

The housing 210 or 210′ may be fixed by a separate support frame 260, and in a case in which the support frame 260 is included, a control unit 240 described below may be also fixed to one portion of the support frame 260.

As described above, when power is applied, the electrode unit 220 may allow metal ions to be eluted in an electrolysis process. Accordingly, the metal ions are coagulated and adsorbed with contaminants included in raw water or treated water so that the contaminants are coagulated into mass-shaped flocs.

To this end, the electrode unit 220 may include a plurality of electrode plates having a planar shape with a predetermined area, and the plurality of electrode plates 221 and 222 may be disposed in the second chamber 212 to be spaced apart from each other by a predetermined distance. For example, the plurality of electrode plates 221 and 222 may include a pair of power electrodes 221 to which power supplied from the outside is applied and a plurality of sacrificial electrodes 222 which are disposed between the pair of power electrodes 221 to be spaced apart from each other by a predetermined distance in parallel so that one surface of one sacrificial electrode faces one surface of another sacrificial electrode.

In this case, the overall number of the sacrificial electrodes 222 disposed between the pair of power electrodes 221 and the distance between the sacrificial electrodes 222 may be changed appropriately according to the entire treatment capacity of raw water. Further, the number of the power electrodes 221 may be two or more, and the overall number of the sacrificial electrodes 222 disposed between the pair of power electrodes 221 and the distance between the sacrificial electrodes 222 may be changed appropriately.

Further, the pair of power electrodes 221 may be formed to have lengths which are relatively longer than the sacrificial electrodes 222 so that power supplied from the outside is easily applied. Thus, the pair of power electrodes 222 disposed in the second chamber 212 is not completely submerged in the raw water stored in the second chamber 212, and the power electrode 221 may be partially exposed to the outside from a surface of the raw water (see FIG. 4).

On the other hand, the plurality of sacrificial electrodes 222 may be disposed to be completely submerged by the raw water or treated water stored in the second chamber 212. Accordingly, since a total area of the plurality of sacrificial electrodes 122 may directly come into contact with the raw water, a reaction area can be increased.

In this case, as described above, the plurality of the electrode plates may be formed of any one of iron, aluminum, stainless steel, and titanium so that metal ions are eluted when power is applied. However, the material of the electrode plate is not limited thereto, and various known materials that are used as an electrode may be used.

Meanwhile, the plurality of the electrode plates 221 and 222 that compose the electrode unit 220 may be directly fixed to the housing 210 or may be fixed to a separate member, and then the separate member may be coupled to the second chamber 212.

For example, as shown in FIGS. 2 to 4, the plurality of electrode plates 221 and 222 may be directly fixed to an inner wall of the housing 210. In this case, a plurality of insertion grooves 215 may be formed inward from the inner wall of the housing 210, which defines the second chamber 212, in a height direction, and more specifically, on a surface of the partition wall 214 and an inner side of the housing 210 that face each other, and the number of the plurality of insertion grooves 215 may correspond to the number of the plurality of electrode plates 221 and 222.

Here, since the insertion grooves 215 have open upper ends and closed lower ends, insertion depths of the lower ends of the electrode plates 221 and 222 may be limited.

Accordingly, when the electrode plates 221 and 222 are inserted into the insertion grooves 215, each of the electrode plates 221 and 222 that are adjacent to each other may be disposed in parallel to be spaced apart from each other by a predetermined distance so that one surface of one electrode plate faces one surface of another electrode plate.

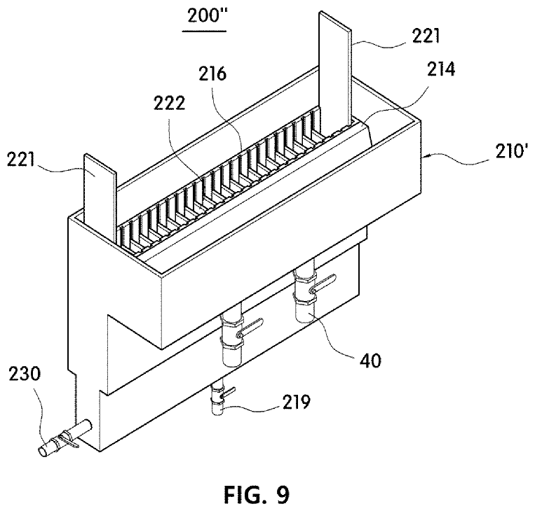

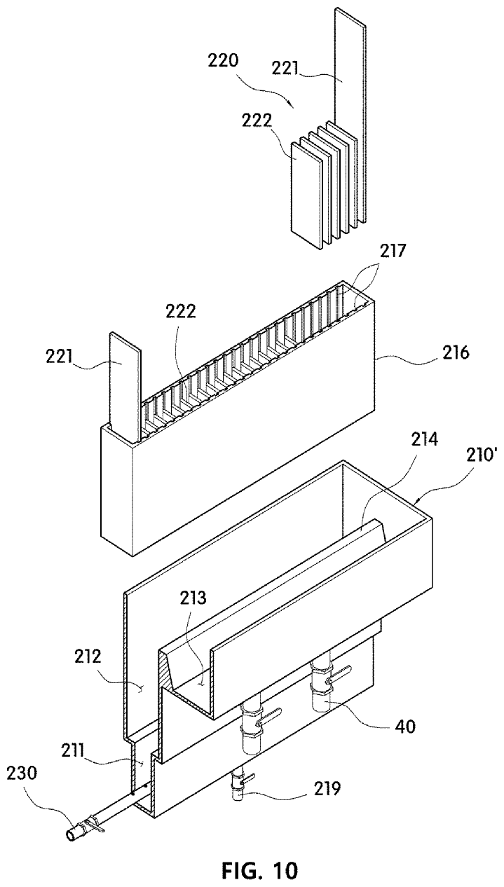

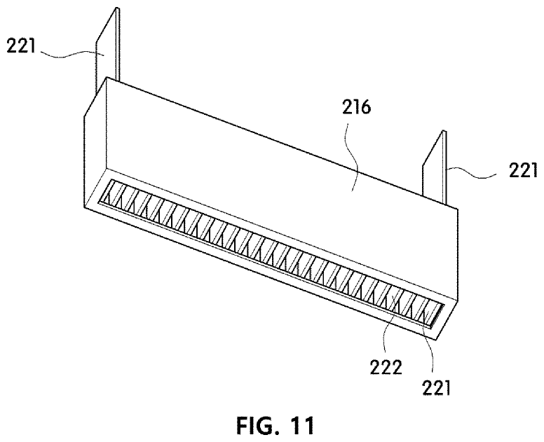

As another example, as shown in FIGS. 9 to 11, the plurality of electrode plates 221 and 222 may be fixed to an electrode case 216, and the electrode case 216 may be coupled to the second chamber 212 of the housing 210′.

In this case, the electrode case 216 may include a plurality of insertion grooves 217 formed inward from facing inner walls thereof in a height direction and may have a box shape that has open upper and lower portions.

Accordingly, when the electrode case 216 is inserted into the second chamber 212 in a state in which each of the plurality of electrode plates 221 and 222 are inserted into the insertion grooves 217, the raw water or treated water that rises up from the first chamber 211 may be smoothly introduced into the electrode case 216 through the open lower portion of the electrode case 216.

Here, the electrode case 216 may be made of an insulator or a nonconductor to prevent a short circuit with the electrode plates 221 and 222, which are inserted into the insertion grooves 217, when power is applied. For example, the electrode case 216 may be made of a material, such as plastic, concrete, or plywood, but the present invention is not limited thereto, and a known insulator or nonconductor may be used as a material of the electrode case 216.

Further, a coating layer that has at least one property of chemical resistance, corrosion resistance, and electric insulation property may be formed on an outer surface of the electrode case 216. Accordingly, surface damage to the electrode case 216, which is due to heavy metal and the like included in raw water or treated water, may be prevented.

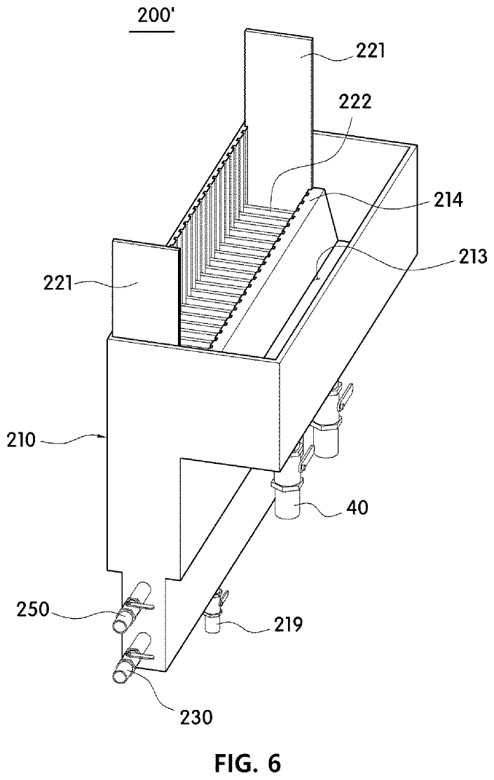

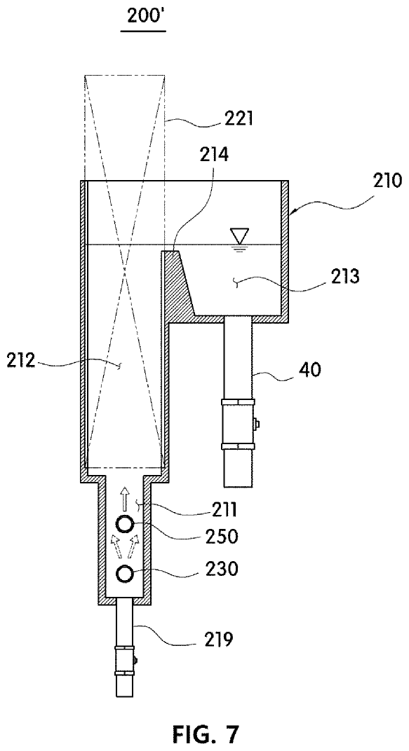

Meanwhile, as shown in FIGS. 6 and 7, the electrocoagulation tank 200′ according to one embodiment of the present invention may include a diffuser 250 that generates bubbles.

The diffuser 250 may be disposed on the first chamber 211 formed below the second chamber 212. Thus, the diffuser 250 may form bubbles in a process in which air supplied from the outside is discharged, and the bubbles may pass between each of the electrode plates 221 and 222 disposed in the second chamber 212.

When the electrocoagulation tank 200′ is operated, the bubbles may prevent flocs, such as polymer hydroxide flocs generated due to an electrocoagulation reaction, from being adhered to the electrode plates 221 or 222. Accordingly, each of the electrode plates 221 and 222 may be maximally prevented from being contaminated due to the polymeric hydroxide flocs adhering to surfaces thereof. Further, since the bubbles may remove the flocs, which adhere to the electrode plates 221 and 222, through a discharge pressure generated when the electrocoagulation tank 220′ is operated, use time of the electrode plates 221 and 222 can be increased, and a treatment performance can be constantly maintained.

For example, as shown in FIG. 8, the diffuser 250 may have a predetermined length and may be a hollow pipe in which a plurality of discharge holes 251 are formed in a longitudinal direction of the diffuser 250 to pass through the diffuser. In this case, the diffuser 250 may be disposed to be parallel with the inlet pipe 230 disposed in the first chamber 211. Here, the diffuser 250 may be disposed at the same height as the inlet pipe 230 and may be disposed on an upper or lower portion of the inlet pipe 230.

In this case, the discharge hole 251 of the diffuser 250 may have a diameter of 0.1 to 10 mm so that bubbles are formed in a predetermined size. Further, a distance between the diffuser 250 and both of the power electrode 221 and the sacrificial electrode 222 may range from 5 to 100 mm, and preferably range from 20 to 30 mm. However, the distance between the diffuser and both of the power electrode and the sacrificial electrode is not limited thereto and may be changed appropriately according to the overall treatment capacity of raw water.

Further, the diffuser 250 may form bubbles while the electrocoagulation tank 200′ is operated, or the diffuser 250 may be operated in a state in which the electrocoagulation tank 200′ is not operated so that a cleaning task for quickly removing the flocs, which adhere to the electrode plates 121 and 122, may be performed using the bubbles.

Meanwhile, the electrocoagulation tanks 200, 200′, and 200″ applied to the present invention may include a control unit 240 for controlling overall operations of the electrocoagulation tanks 200, 200′, and 200″ such as supply of power, cut-off of power, and an amount of power or a current density applied to the power electrode 221.

In this case, the control unit 240 may periodically change the polarity of the power applied to the pair of power electrodes 221. Accordingly, the polarity applied to both surfaces of the electrode plates 221 and 222 may be periodically changed in the electrocoagulation reaction so that the both surfaces of the electrode plates 221 and 222 are used evenly, and thus the replacement period of the electrode plates 221 and 222 can be extended.

Here, the control unit 240 may be separately provided in each of a plurality of electrocoagulation tanks 200, 200′, and 200″ or may control the plurality of electrocoagulation tanks 200, 200′, and 200″ using a single control unit.

Meanwhile, the pollutant removing system for water treatment 1 according to one embodiment of the present invention may include an additional component, such as a known settling tank, a sludge thickening tank, a dehydrating tank, and a reverse osmosis system used in a general water treatment system, in addition to the raw water supply tank 100, the electrocoagulation tanks 200, 200′, and 200″, and the separation membrane tank 300 that are described above.

Hereinabove, the above embodiments of the present invention have been described, but the scope of the present invention is not limited to the embodiments described in this specification. Those skilled in the art may easily suggest other embodiments by addition, change, or removal of components without departing from the spirit and scope of the present invention, but the suggested embodiments are also included within the scope of the appended claims.

1. A pollutant removing system for water treatment, comprising:
a raw-water supply tank;
a separation membrane tank; and
a plurality of electrocoagulation tanks disposed between the raw-water supply tank and the separation membrane tank and configured to coagulate a contaminant included in raw water using a principle of electrocoagulation,
wherein the plurality of electrocoagulation tanks are connected in series.

2. The pollutant removing system of claim 1, wherein the plurality of electrocoagulation tanks have the same treatment capacity.

3. The pollutant removing system of claim 1, wherein the plurality of electrocoagulation tanks include the same number of electrode plates.

4. The pollutant removing system of claim 1, wherein each of the electrocoagulation tanks includes:
a housing that includes an internal space with an open upper portion; and
an electrode unit which is disposed in the internal space and includes a plurality of electrode plates disposed therein to be spaced apart from each other so that the contaminant, which is included in the raw water supplied from the outside, is coagulated using the principle of electrocoagulation,
wherein the internal space includes a first chamber into which the raw water is introduced, a second chamber which is formed above the first chamber and in which the electrode unit is disposed, and a third chamber which temporarily stores treated water of which an electrocoagulation reaction is completed in the second chamber.

5. The pollutant removing system of claim 4, wherein the plurality of electrode plates include a pair of power electrodes to which power supplied from the outside is applied and a plurality of sacrificial electrodes which are disposed between the pair of power electrodes in parallel to be spaced apart from each other by a predetermined distance.

6. The pollutant removing system of claim 5, wherein insertion grooves for fixing positions of the power electrodes and the sacrificial electrodes are formed inward from an inner wall of the housing, which defines the second chamber, in a height direction.

7. The pollutant removing system of claim 5, wherein the electrocoagulation tank further includes an electrode case to which the power electrodes and the sacrificial electrodes are coupled to be attachable or detachable,
wherein the electrode case includes insertion grooves formed inward from an inner wall thereof in a height direction so that positions of the power electrodes and the sacrificial electrodes are fixed, and the electrode case is coupled to the second chamber of the housing.

8. The pollutant removing system of claim 4, wherein, in the electrocoagulation tank, an inlet pipe that has a predetermined length and has a plurality of spray holes formed therein is disposed in the first chamber,
wherein the inlet pipe is disposed in a direction parallel with an arrangement direction of the electrode plates.

9. The pollutant removing system of claim 4, wherein, in the electrocoagulation tank, a diffuser, which has a predetermined length and has a plurality of discharge holes formed therein, is disposed in the first chamber,
wherein the diffuser discharges bubbles through the discharge holes using air supplied from the outside.

10. The pollutant removing system of claim 4, wherein the second chamber and the third chamber are partitioned by a partition wall which protrudes to a predetermined height in the inner space, and treated water of which an electrocoagulation reaction is completed in the second chamber passes over an upper end of the partition wall and moves to the third chamber.

11. The pollutant removing system of claim 4, wherein at least one discharge hole for discharging the treated water to the outside is formed in a bottom surface of the third chamber.

12. The pollutant removing system of claim 4, wherein the housing is made of an insulator or a nonconductor.

13. The pollutant removing system of claim 12, wherein an outer surface of the housing is coated with a coating layer that has at least one property of chemical resistance, corrosion resistance, and electric insulation property.

14. The pollutant removing system of claim 4, wherein the electrocoagulation tank includes a control unit for controlling power to be supplied to the electrode unit,
wherein the control unit periodically changes polarity of power applied to the electrode unit.

15. The pollutant removing system of claim 4, wherein the plurality of electrode plates are made of any one among iron, aluminum, stainless steel, and titanium.
